(19) United States
(12) Patent Application Publication
(10) Pub. No.: US 2012/0169640 A1
(43) Pub. Date: Jul. 5, 2012

(54) ELECTRONIC DEVICE AND CONTROL METHOD THEREOF

(76) Inventor: JaoChing Lin, Taipei City (TW)

(21) Appl. No.: 13/342,996

(22) Filed: Jan. 4, 2012

(30) Foreign Application Priority Data
Jan. 4, 2011 (TW) 100100183

(51) Int. Cl. G06F 3/041

(52) U.S. Cl. 345/173

(57) ABSTRACT

The present invention relates to an electronic device and a control method thereof. The control method includes the following steps of: determining whether a touch object contacts a touch surface; and determining whether the touch object contacts one touch area or sequentially contacts at least two touch areas. If the touch object contacts one touch area, an operation of the touch area is activated. If the touch object sequentially contacts at least two touch areas, a predetermined special function is activated. Accordingly, time for selecting the functions can be reduced and convenience can be enhanced during operation.

### BACKGROUND OF THE INVENTION

1. Field of the Invention

The present invention relates to an electronic device and a control method thereof, and more particularly, to an electronic device and a control method capable of activating a desired function corresponding to a contact status between a touch object and a touch area. Therefore, time for selecting the function can be reduced and convenience can be enhanced during operation.

2. Description of the Prior Art

Touch pads are widely used in various electronic products including, for example, portable computers, personal digital assistants, mobile phones and other electronic systems. Existing touch pads are divided into four categories, including resistance-type, capacitance-type, acoustic-type and optical-type, based on their sensing principles. The resistance-type and the capacitance-type touch pads are more popular, each serving as an input device in which an electronic-conductive object such as a finger or a touch stylus of a user contacts a panel of the touch pad or slides thereon, whereby a cursor or an absolute coordinate can be moved and other functions can be activated, such as a function of stimulating a key.

When the finger or the electrical-conductive object contacts the panel of the touch pad, the amount of capacitance or resistance at the contact position will change. A processing element electrically connected to the touch pad can convert the change in capacitance or resistance into a sensed value, and in turn determine the contact position, displacement, and motion direction of the finger or the electrical-conductive object. When the finger or the electrical-conductive object clicks, drags or double-clicks the panel of the touch pad, the time of the finger or the electrical-conductive object touching, leaving or moving on the panel is used as the basis for determination.

Originally, the touch pad only had a cursor-mode function to replace the cursor of a traditional mouse. Later, in order to perform other functions, complicated finger motions had to be employed, such as clicking, double-clicking, dragging, scrolling actions accomplished by one finger, or zoom-in, zoom-out, and rotating a picture accomplished by several fingers. Thus, a complicated recognition method is programmed in the touch pad for analyzing the above-mentioned finger motions.

Determining the finger motion on the touch pad includes detecting the position or displacement of the finger (or the electrical-conductive object) on the touch pad. Then, the position and displacement of the touch area is used as a basis for controlling an object, browsing a window or moving a cursor. Thus, many manufacturers add objects on predetermined areas of the touch pad and detect the touch condition or displacement of the finger (or the electrical-conductive object) on the predetermined areas, thereby activating some special finger motions to control the pictures displayed on the window of the electronic device. On a common portable electronic device, the area of the touch pad is limited, so that flexibility of the finger motions and applicability of the touch pad are also restricted. As a result, the user has to employ complicated finger motions to browse the window of the electronic device. Therefore, when the pictures displayed on the window are to be changed, it is inconvenient for the user to browse the different pictures on the window, and the user has to memorize the individual finger motions.

According to the above, the prior art has the following problems:

(I) low expansion of functions of the touch pad due to the limited area of the touch pad;

(II) inconvenience in browsing the pictures on the window; and

(III) difficulty in memorizing the individual finger motions.

### SUMMARY OF THE INVENTION

In order to solve the above problems, an objective of the present invention is to provide an electronic device and a control method capable of reducing time for selecting functions.

Another objective of the present invention is to provide an electronic device and a control method capable of enhancing the convenience in operation.

Another objective of the present invention is to provide an electronic device and a control method capable of reducing mode switch keys and simplifying operation steps.

The present invention provides an electronic device and a control method. The electronic device has a touch unit, a display unit, and a control unit. The touch unit has a touch surface. The touch area has at least one touch area corresponding to an operation of the touch unit. The control method comprises steps of: determining whether a touch object contacts the touch area; and determining whether the touch object contacts one of the touch areas or continuously/sequentially contacts at least two touch areas. If the touch object contacts one of the touch areas, an operation of the touch area contacted by the touch object is activated and displayed on the display unit. If the touch object continuously/sequentially contacts at least two touch areas, a predetermined special function is activated, such as a page-up function or a page-down function, and the special function is displayed on the display unit. Therefore, according to the control method of the present invention, time for selecting the function is reduced, convenience is enhanced during operation, and the steps of the operation are simplified.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a flow chart showing the steps of the method of the present invention;

FIG. 1B is a flow chart showing the steps of the method of the present invention;

FIG. 2A is a perspective view showing an electronic device of the present invention;

FIG. 2B is a block view showing the electronic device of the present invention;

FIG. 3A is a schematic view (I) showing the implementation of the control method of the present invention;

FIG. 3B is a schematic view (II) showing the implementation of the control method of the present invention;

FIG. 3C is a schematic view (I) showing the display of the control method of the present invention;

FIG. 4A is a schematic view (III) showing the implementation of the control method of the present invention;

FIG. 4B is a schematic view (II) showing the display of the control method of the present invention;

FIG. 5A is a schematic view (I) showing another implementation of the control method of the present invention;

FIG. 5B is a schematic view (I) showing another display of the control method of the present invention;

FIG. 6A is a schematic view (II) showing another implementation of the control method of the present invention;

FIG. 6B is a schematic view (I) showing another display of the control method of the present invention;

FIG. 7A is a schematic view (III) showing another implementation of the control method of the present invention;

FIG. 7B is a schematic view (III) showing another implementation of the control method of the present invention;

FIG. 8A is a schematic view (I) showing a further implementation of the control method of the present invention;

FIG. 8B is a schematic view (I) showing a further display of the control method of the present invention;

FIG. 9A is a schematic view (II) showing a further implementation of the control method of the present invention;

FIG. 9B is a schematic view (II) showing a further display of the control method of the present invention;

FIG. 10A is a schematic view (I) showing a still further display of the control method of the present invention;

FIG. 10B is a schematic view (II) showing a still further display of the control method of the present invention;

FIG. 11A is a schematic view (I) showing a still further implementation of the control method of the present invention; and

FIG. 11B is a schematic view (II) showing a still further implementation of the control method of the present invention.

### DETAILED DESCRIPTION

The above objectives and structural and functional features of the present invention will be described in more detail with reference to a preferred embodiment thereof shown in the accompanying drawings.

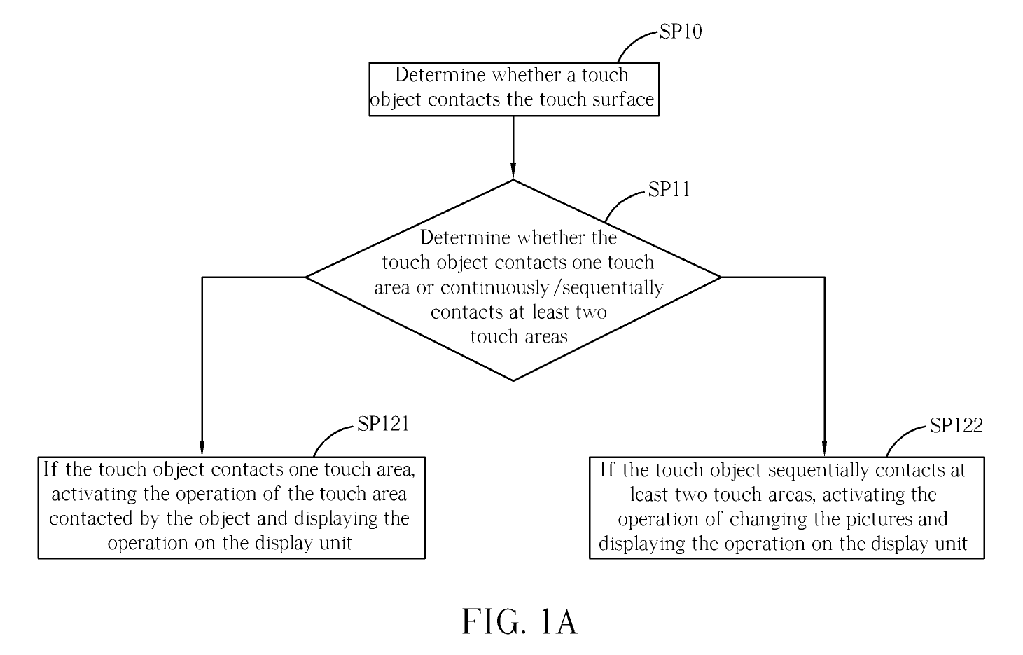

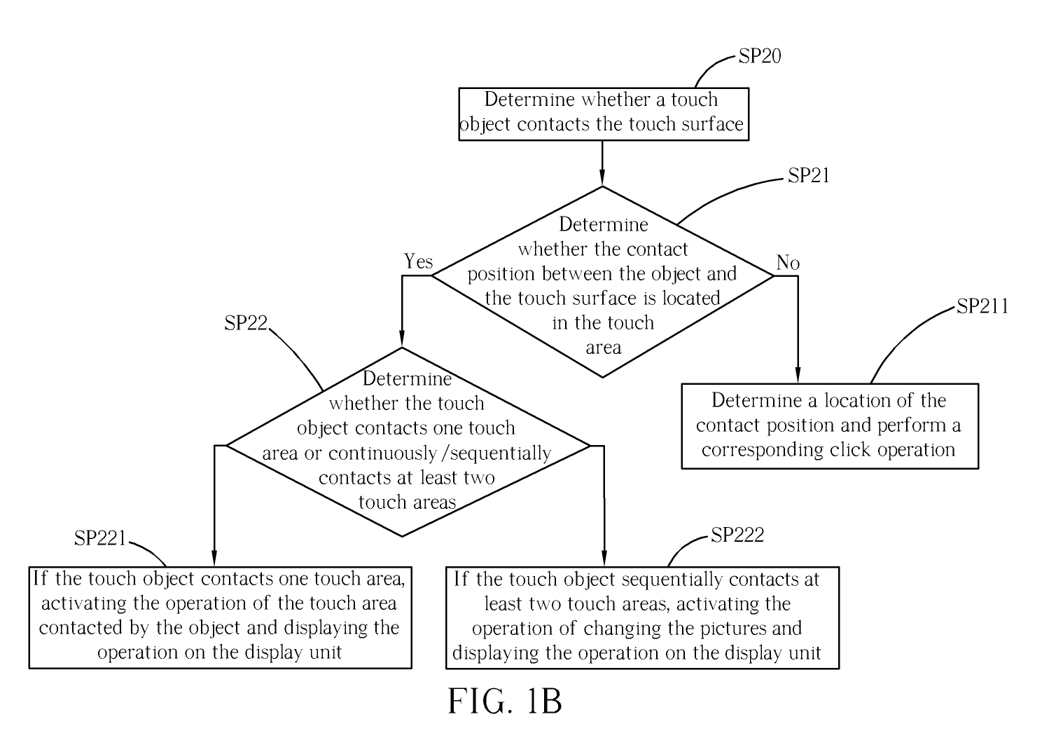

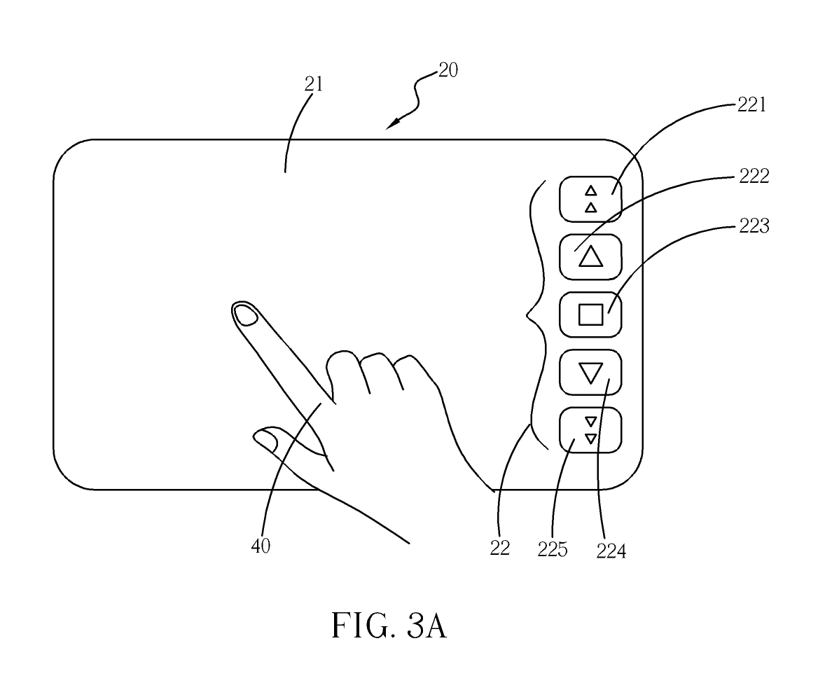

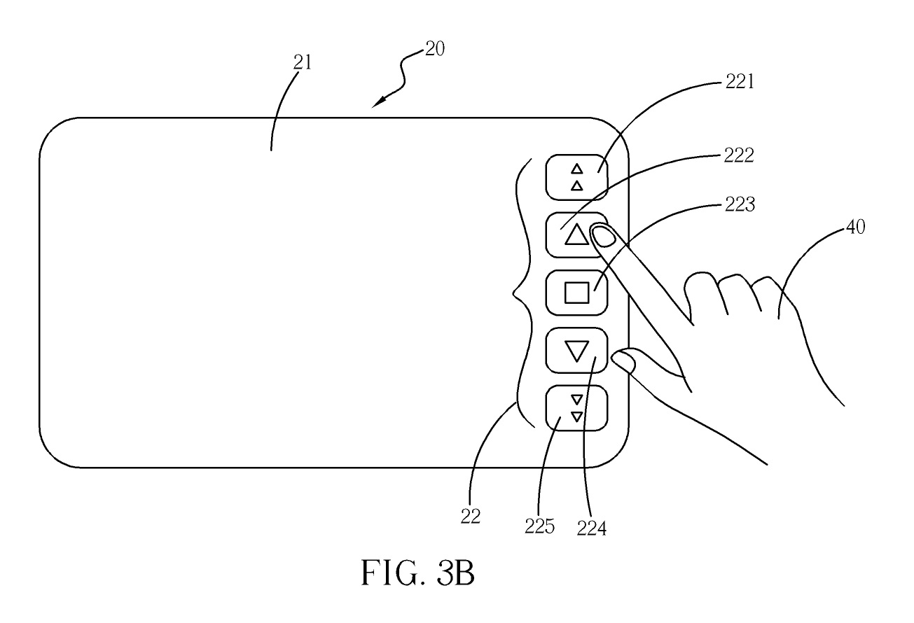

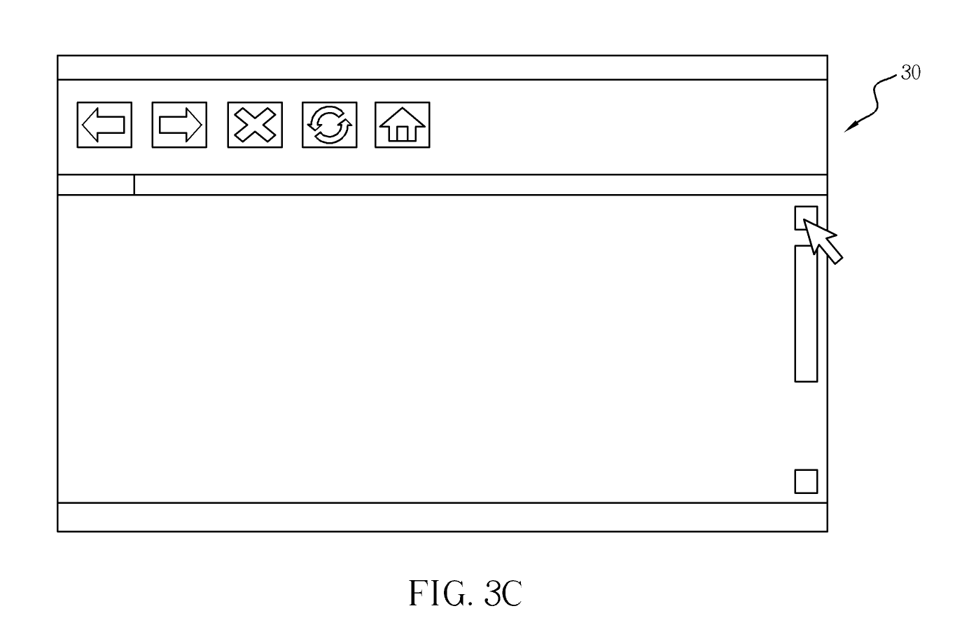

Please refer to FIGS. 1A, 1B, 2A, 2B and 3A. The present invention provides an electronic device and a control method. In the present embodiment, the electronic device 10 has a touch unit 20, a display unit 30, and a control unit 50. The touch unit 20 is electrically connected to the display unit 30 and the control unit 50. The touch unit 20 has a touch surface 21. The touch surface 21 has at least one touch area 22. A user can contact the touch surface 21 of the touch unit 20 with a touch object 40 (FIG. 3A), so that the control unit 50 is activated to control the display unit 30 to display a picture accordingly. The control unit 50 can be a processor, a control chip, a central processing unit (CPU) or the like. The touch unit 20 is provided in the electronic device 10, such as a notebook. The control method of the present invention includes the following steps:

Step 10 (sp 10) is to determine whether a touch object contacts the touch surface.

Step 11 (sp11) is to determine whether the touch object contacts one touch area or continuously/sequentially contacts at least two touch areas. If the touch object contacts one touch area, continue to step 121 (sp121). If the touch object continuously/sequentially contacts at least two contact areas, continue to step 122 (sp122).

Step 121 (sp121) is to perform a predetermined operation of the touch area contacted by the touch object and to display the predetermined operation on the display unit when the touch object contacts one touch area.

Step 122 (sp 122) is to perform a predetermined special function and to display the predetermined special function on the display unit when the touch object continuously/sequentially contacts at least two touch areas.

Further, another control method includes the following steps:

Step 20 (sp20) is to determine whether a touch object contacts the touch surface.

Step 21 (sp21) is to determine whether the contact position between the touch object and the touch surface is located in the touch area. If the contact position is located in the touch area, continue to step 22 (sp22). If the contact position is not located in the touch area, continue to step 211 (sp 211).

Step 211 (sp211) is to determine a location of the contact position and perform a corresponding clicking operation.

Step 22 (sp22) is to determine whether the touch object contacts one touch area or continuously/sequentially contacts at least two touch areas. If the touch object contacts one touch area, continue to step 221 (sp221). If the touch object continuously/sequentially contacts at least two touch areas, continue to step 222 (sp222).

Step 221 (sp221) is to activate a predetermined operation of the touch area contacted by the touch object and to display the predetermined operation on the display unit when the touch object contacts one touch area.

Step 222 (sp222) is to perform a predetermined special function and to display the predetermined special function on the display unit when the touch object continuously/sequentially contacts at least two touch areas.

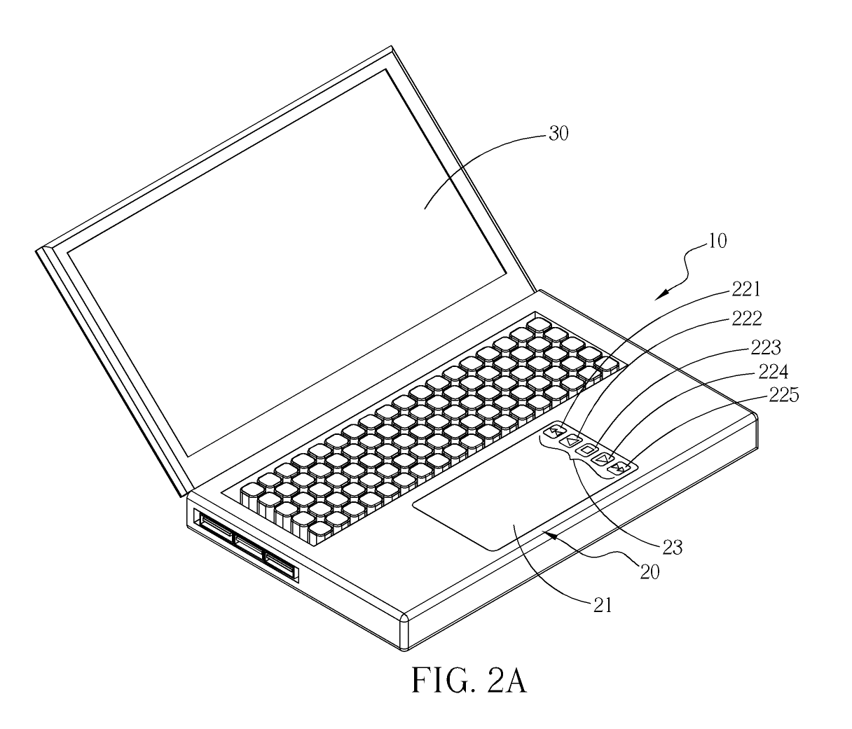

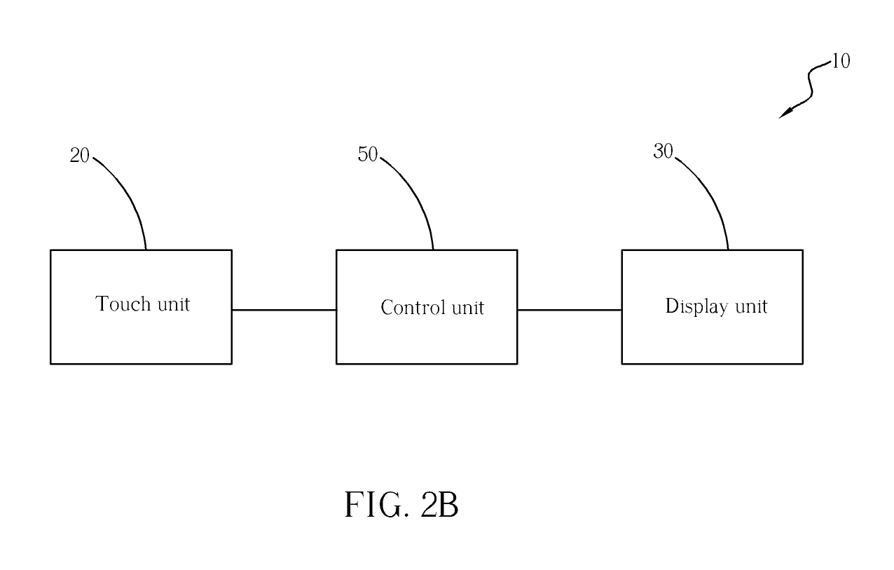

Please refer to FIGS. 2B, 3A, 3B, and 3C. The touch unit 20 has a touch surface 21. The touch surface 21 has a plurality of touch areas 22. Each of the touch areas 22 is marked with a different icon and is disconnected from other touch areas. In the present embodiment, the touch areas 22 are defined as different operational areas including a fast-scroll-up area 221, a scroll-up area 222, a pause area 223, a scroll-down area 224, and a fast-scroll-down area 225. Correspondingly, a fast-scroll-up operation, a scroll-up operation, a pause operation, a scroll-down operation, and a fast-scroll-down operation can be performed and displayed on the display unit 30 of the electronic device 10.

Thus, a user can utilize a touch object 40 such as a finger or a touch stylus to contact the touch areas 22 of the touch unit 20. First, the touch unit 20 determines whether the touch object 40 contacts the touch surface 21, and then determines whether the contact position of the touch object 40 on the touch surface 21 is located in the touch area 22.

If the contact position of the touch object 40 is not located in the touch area 22, the control unit 22 determines a location of the contact position and performs a corresponding clicking operation.

If the contact position of the touch object 40 is located in the touch areas 22, the touch unit 20 further determines whether the touch object 40 contacts one touch area 22 or continuously/sequentially contacts at least two touch areas.

If the touch object 40 contacts one touch area 22, a corresponding operation of the touch area 22 contacted by the touch object 40 is activated and displayed on the display unit 30. As shown in FIG. 3B, the touch object 40 contacts the scroll-up area 222. A processing element (not shown) of the touch unit 20 activates the scroll-up operation according to the action of the touch object 40 contacting the scroll-up area 222, and controls the picture displayed on the display unit 30 to be scrolled up.

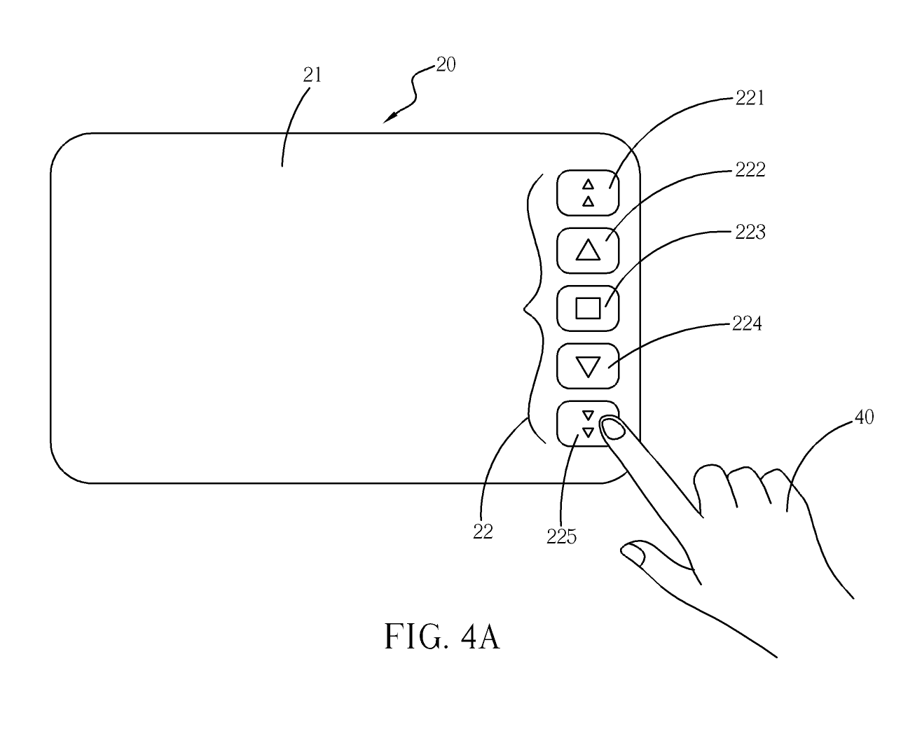

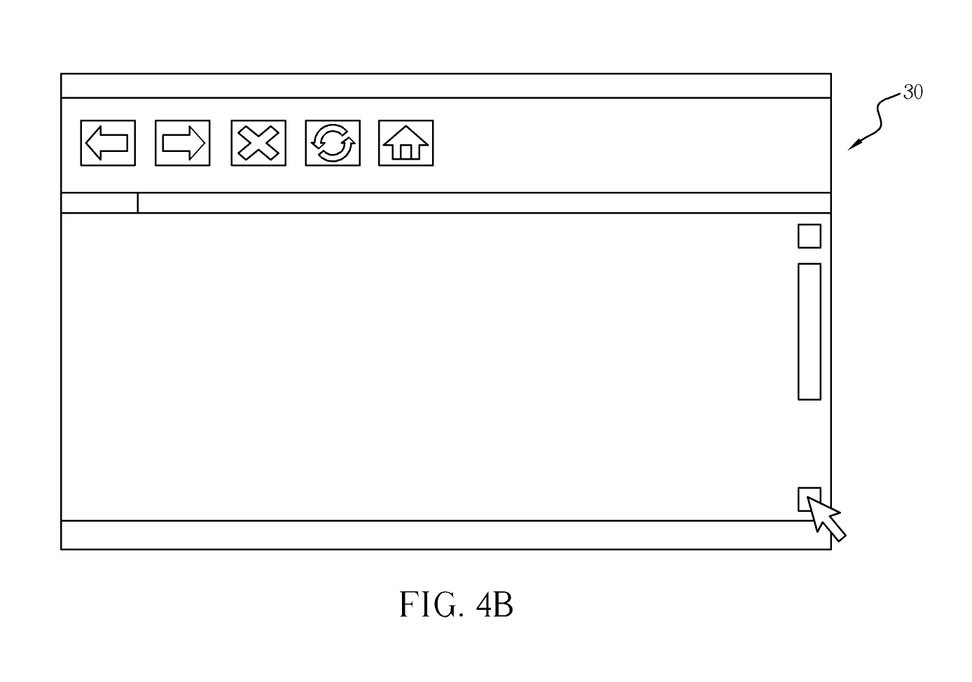

As shown in FIGS. 4A and 4B, when the touch object 40 contacts the fast-scroll-down area 225, the processing element of the touch unit 20 activates the fast-scroll-down operation according to the action of the touch object 40 contacting the fast-scroll-down area 225, and controls the picture displayed on the display unit 30 to be fast scrolled down. Similarly, when the touch object 40 contacts the scroll-up area 221, the pause area 223, or the scroll-down area 224, the scroll-up operation, the pause operation, or the scroll-down operation can be activated and displayed on the display unit 30.

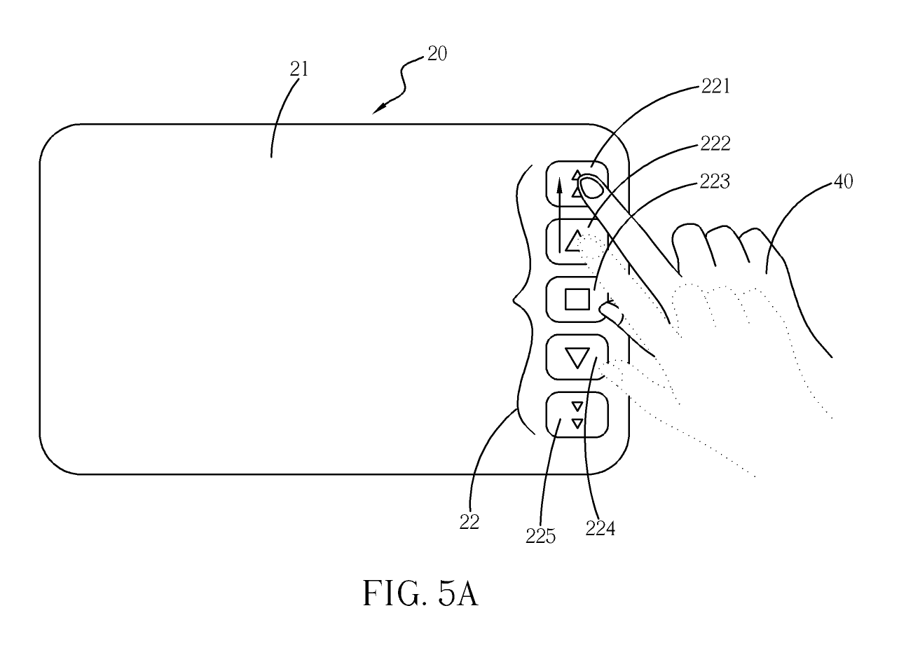

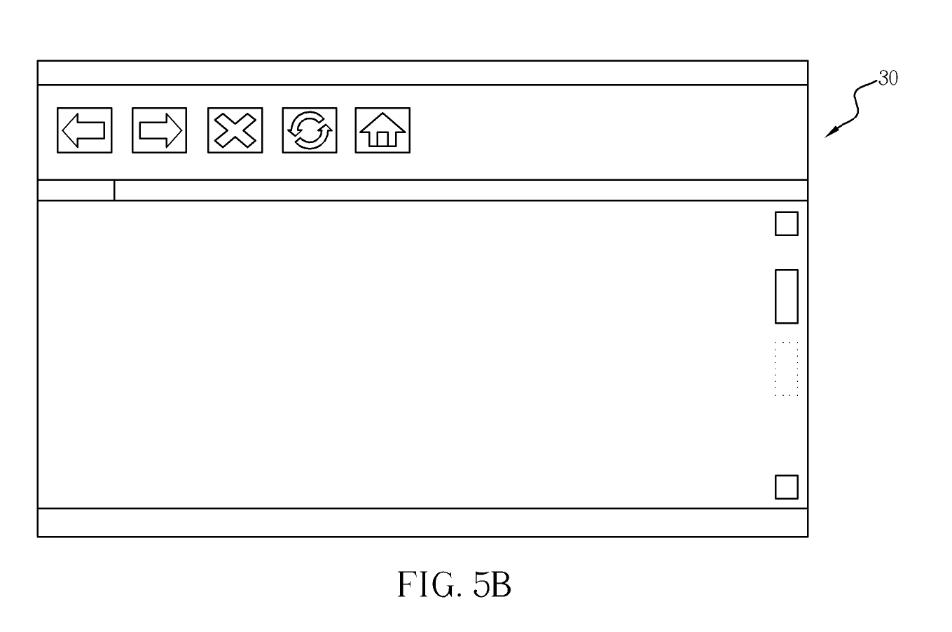

Please refer to FIGS. 5A and 5B, which show another preferred embodiment of the present invention. If the electronic device 10 determines the touch object 40 continuously/sequentially contacts at least two touch areas, a predetermined special function is performed. Hereinafter, a continuous contact means that the touch object 40 contacts one touch area 22 and slides to contact another touch area 21 without leaving the touch surface 21. On the contrary, a sequential contact means that the touch object 40 contacts one touch area 22, leaves the touch area 21, and then contacts another touch area 22 within a predetermined time interval.

In the present embodiment, the touch object 40 can contact the scroll-up area 222 first, and then slide to the fast-scroll-up area 221 without leaving the touch surface 21. Alternatively, the touch object 40 can also contact the scroll-up area 222, leave the touch surface 21, and then contact the fast-scroll-up area 221 within a predetermined time interval.

According to the contact with the scroll-up area 222 and the fast-scroll-up area 221, the processing element of the touch unit 20 performs a predetermined special function of changing the pictures displayed on the display unit 30, and controls the display unit 30 to display a picture of a previous page, which is a special function equivalent to the action of pressing the “Page Up” key on a keyboard.

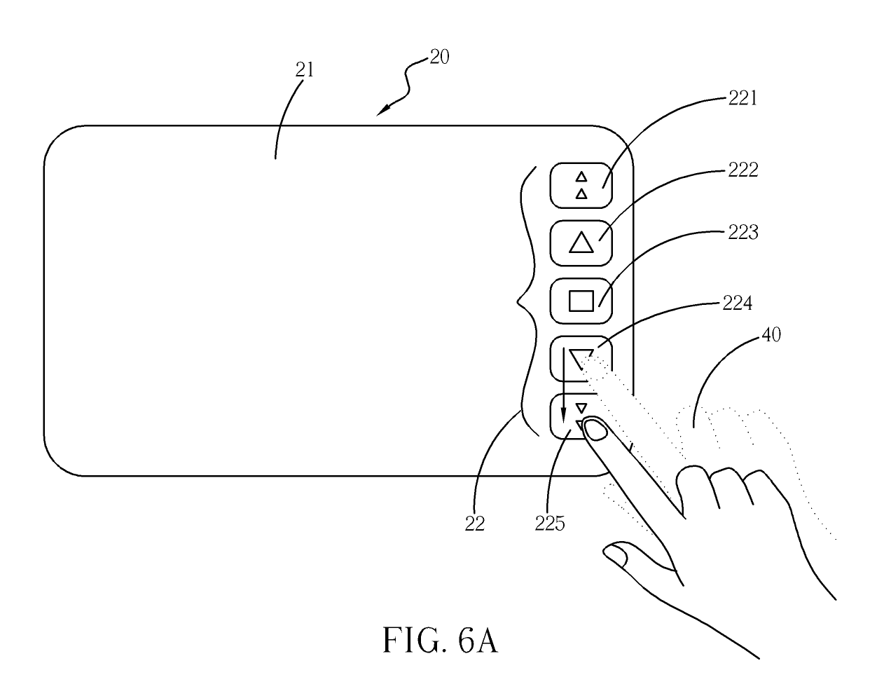

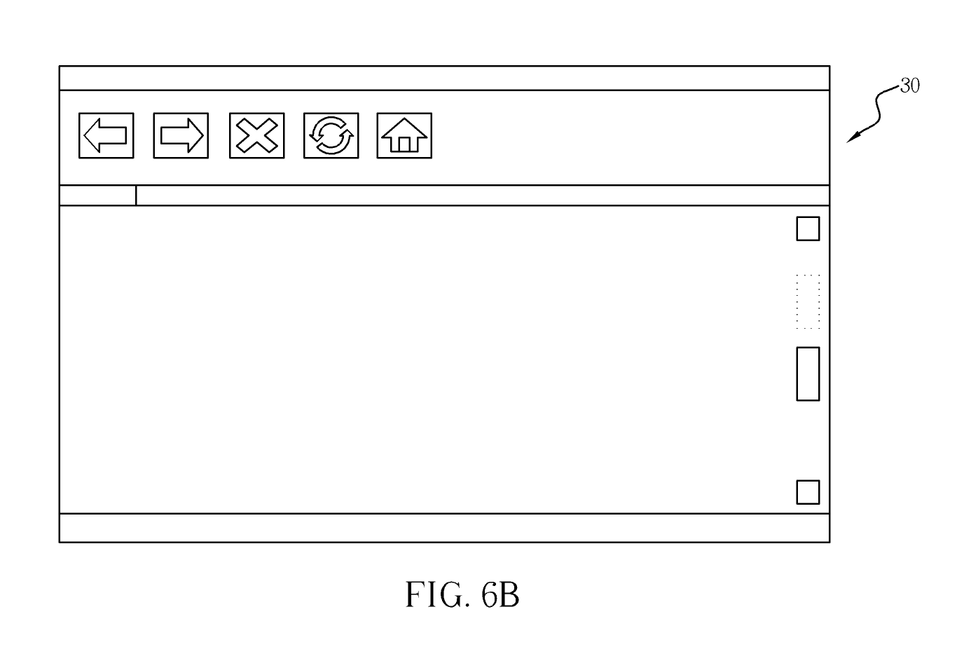

Please refer to FIGS. 6A and 6B, which show another embodiment of the present invention. In the present embodiment, the touch object 40 can contact the scroll-down area 224, and then slide to the fast-scroll-down area 225 without leaving the touch surface 21. Alternatively, the touch object 40 can also contact the scroll-down area 224, leave the touch surface 21, and then contact the fast-scroll-down area 225 within a predetermined time interval.

According to the contact with the scroll-down area 224 and the fast-scroll-down area 225, the processing element of the touch unit 20 performs the function of changing the pictures, and controls the display unit 30 to display a picture of a next page, which is a special function equivalent to the action of pressing the “Page Down” key on a keyboard.

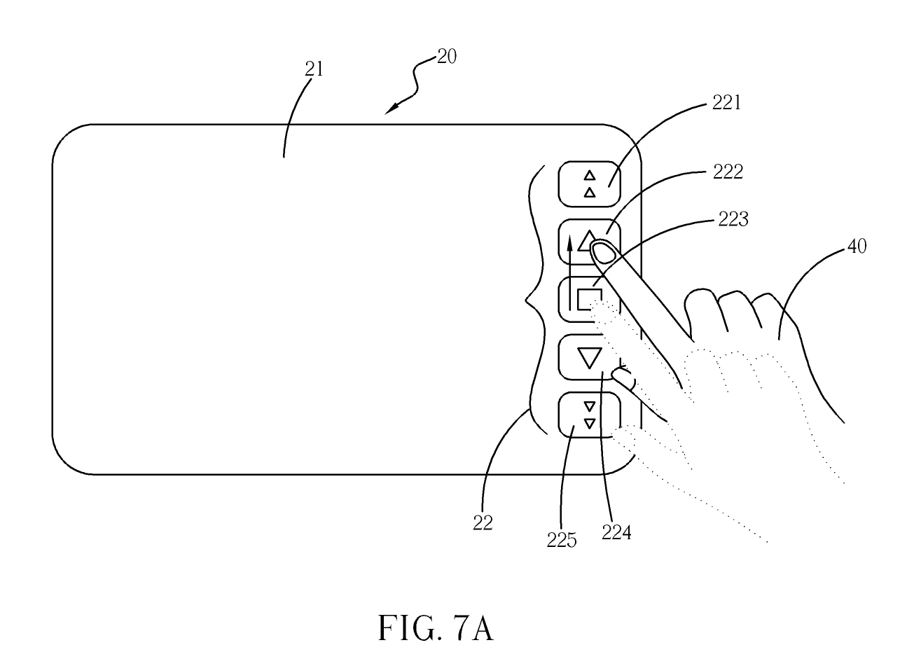

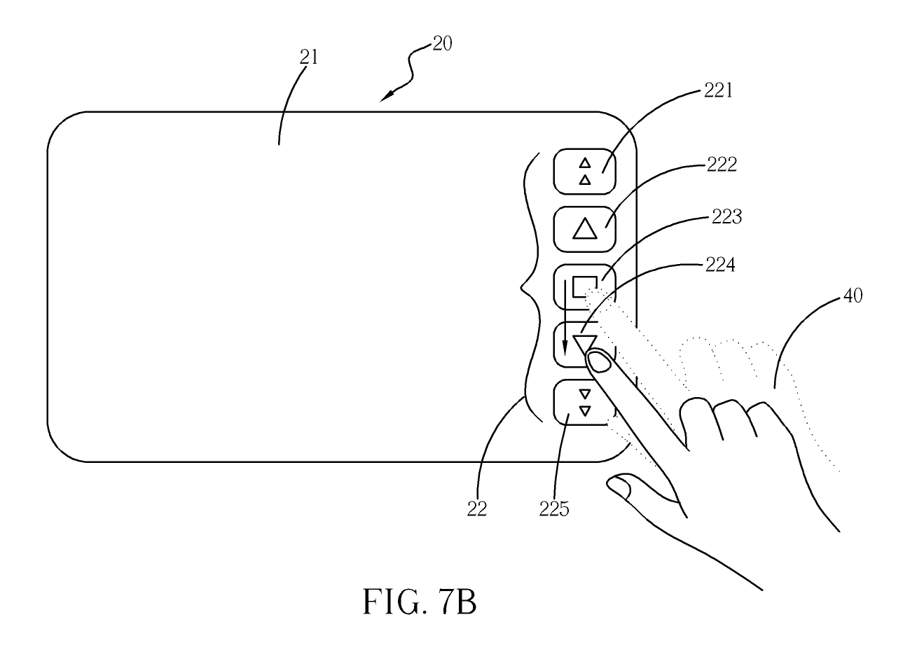

Please refer to FIGS. 7A and 7B, which show another embodiment of the present invention. In the present embodiment, the touch object 40 can contact the pause area 223 and then slide to the scroll-up area 222 without leaving the touch area 21. Alternatively, the touch object 40 can contact the pause area 223, leave the touch surface 21, and then contact the scroll-up area 222.

According to the sequence of the contact with the at least two touch areas 22, the processing element of the touch unit 20 performs the function of changing the pictures, and controls the display unit 30 to display the picture of the previous page (also refer to FIG. 5B), which is a special function equivalent to the action of pressing the “Page Up” key on a keyboard.

On the other hand, the touch object 40 can contact the pause area 223 and slide to the scroll-down area 224 without leaving the touch surface 21. Or, the touch object 40 can contact the pause area 223, leave the touch surface 21, and then contact the scroll-down area 224 within a predetermined time interval. According to the sequence of the contact with at least two touch areas 22, the processing element of the touch unit 20 performs the function of changing the pictures, and controls the display unit 30 to display the picture of the next page (FIG. 6B), which is a special function equivalent to the action of pressing the “Page Down” key on a keyboard.

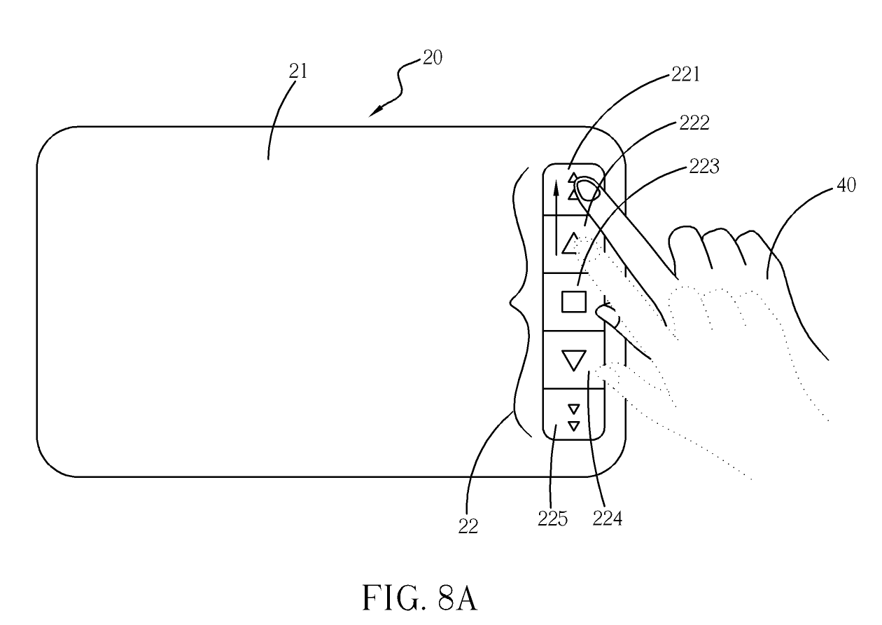

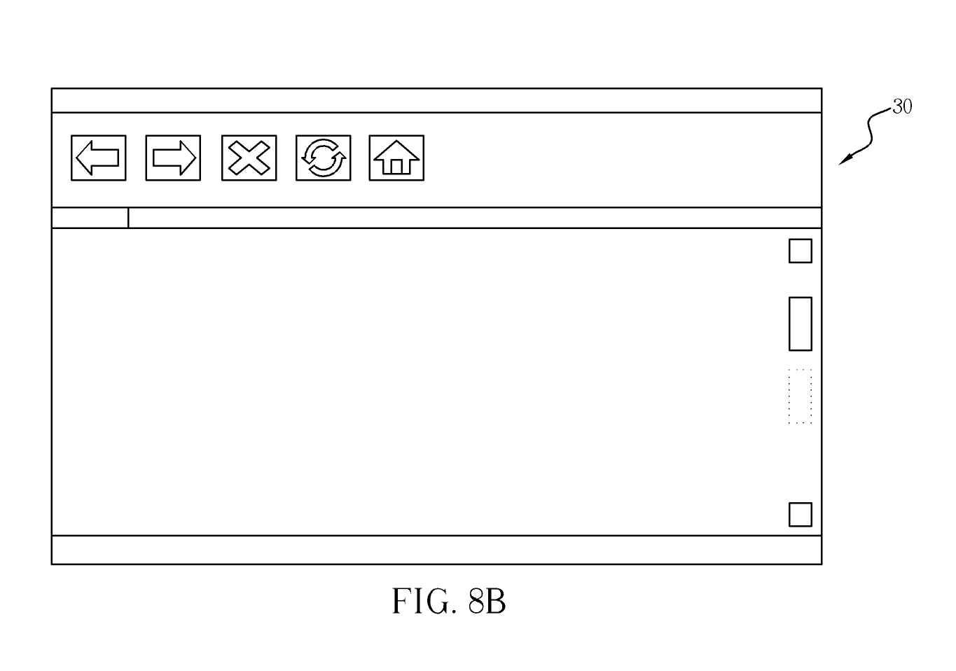

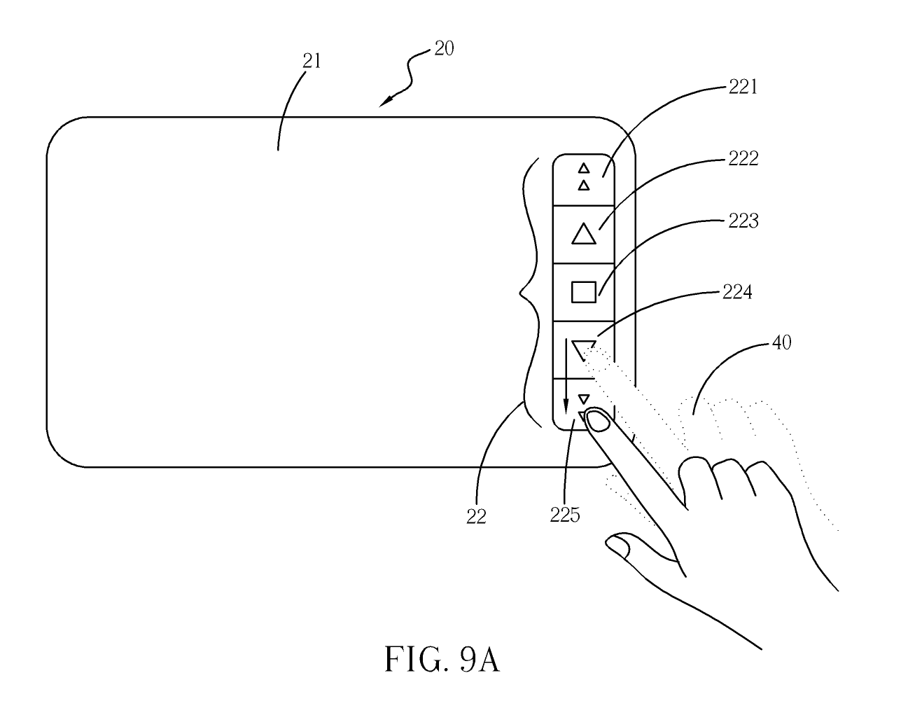

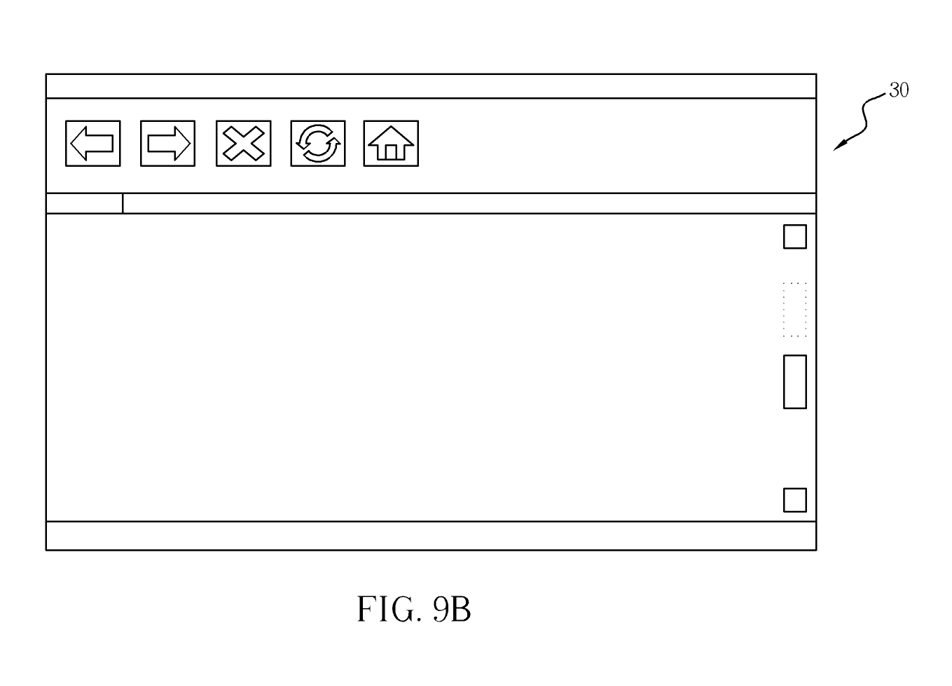

Please refer to FIGS. 8A, 8B, 9A and 9B, which show another embodiment of the present invention. In the present embodiment, the respective touch areas of the touch surface are connected to each other. The touch object 40 may continuously/sequentially contact at least two touch areas 22 connected to each other, for example, the touch object 40 may contact the scroll-up area 222 and the fast-scroll-up area 221. According to the contact with the scroll-up area 222 and the fast-scroll-up area 221, the processing element of the touch unit 20 performs the function of changing the pictures, and controls the display unit 30 to display the picture of the previous page, and the processing element of the touch unit 20 controls page changing speed according to a moving speed of the touch object 40 from the scroll-up area 222 to the fast-scroll-up area 221.

If the touch object 40 continuously/sequentially contacts the scroll-down area 224 and the fast-scroll-down area 225, according to the contact with the scroll-down area 224 and the fast-scroll-down area 225, the processing element of the touch unit 20 performs the function of changing the pictures, and controls the display unit 30 to display the picture of next page, and the processing element of the touch unit 20 controls the page changing speed according to the moving speed of the touch object 40 from the scroll-down area 224 to the fast-scroll-down area 225.

The touch unit 20 activates a predetermined special function corresponding to a contact status between the touch object 40 and the touch area 22 to control the display unit 30 to display the picture of the previous page (like the action of pressing the “Page UP” key on a keyboard) or the picture of the next page (like the action of pressing the “Page Down” key on a keyboard). In this way, time for selecting the functions can be reduced and convenience can be enhanced during operation.

If the touch object 40 continuously/sequentially contacts at least two touch areas, the predetermined special functions are performed. Besides changing the pictures displayed on the display unit 30, the predetermined special functions may be arranged according to the user's need, such as controlling displayed web pages, controlling volume, controlling picture brightness, or activating an application software.

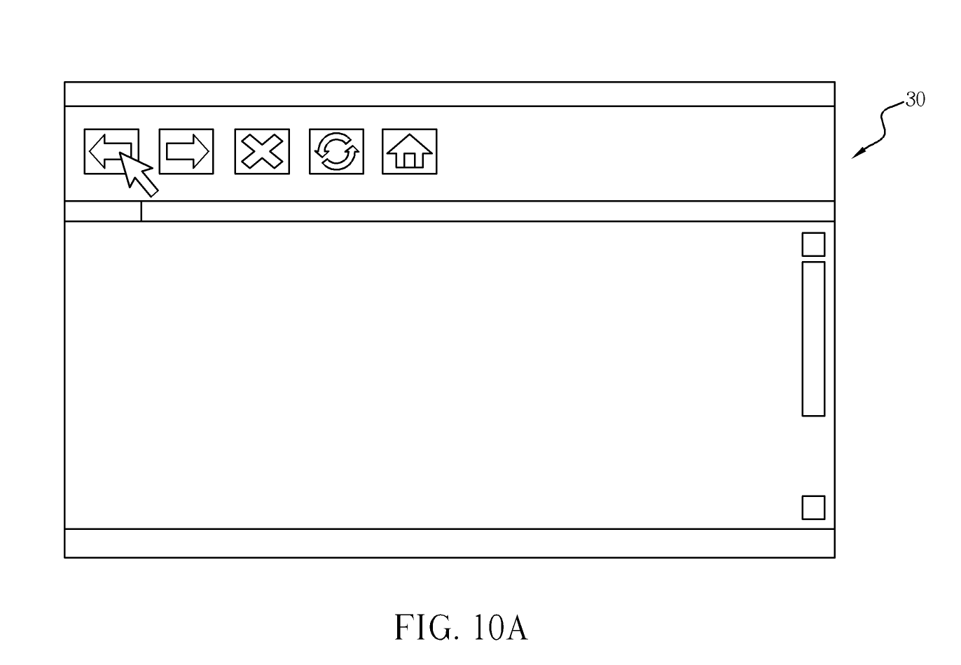

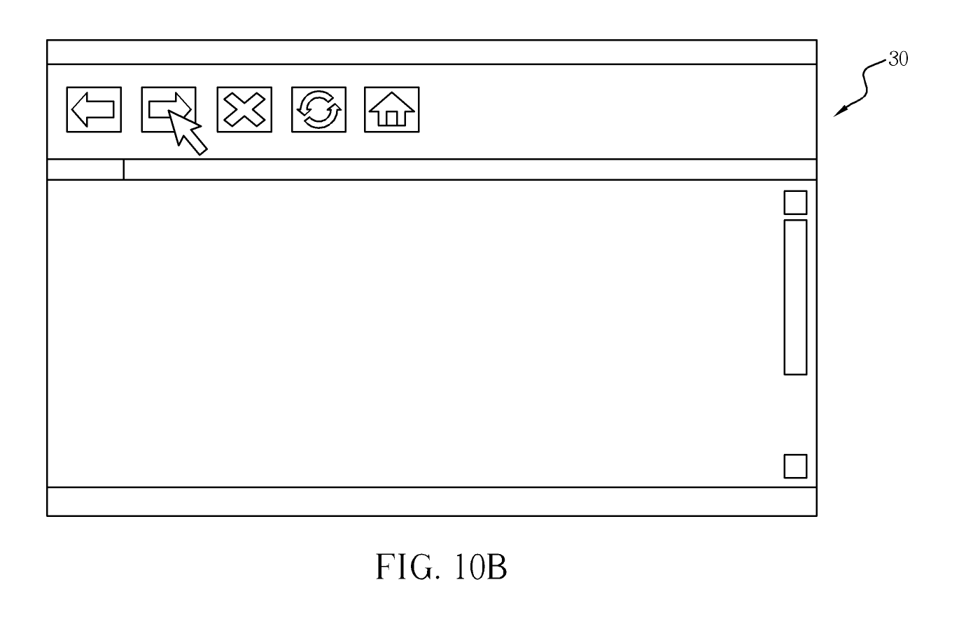

Please refer to FIGS. 5A, 5B, 10A and 10B, which show another embodiment of the present invention. In the present embodiment, the selection and control of displayed web pages is described as an example. When the touch object 40 continuously/sequentially contacts the scroll-up area 222 and the fast-scroll-up area 221, the processing element of the touch unit 20 controls the display unit 30 to display a previous web page. On the other hand, when the touch object 40 continuously/sequentially contacts the scroll-down area 224 and the fast-scroll-down area 225, the processing element of the touch unit 20 controls the display unit 30 to display the next web page. In this way, time for selecting the web pages can be reduced and convenience can be enhanced during operation.

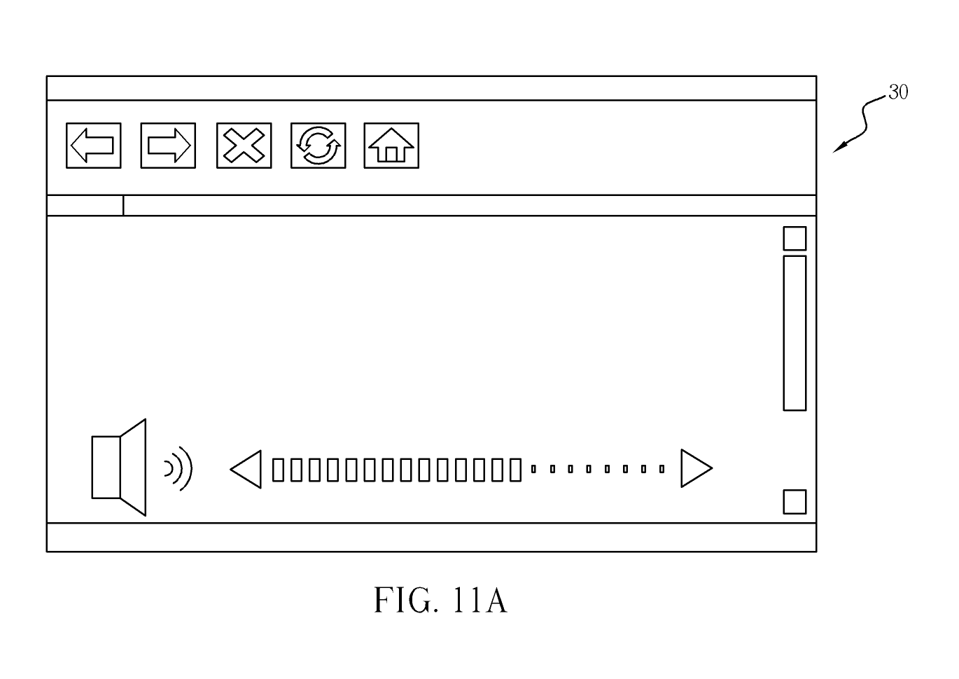

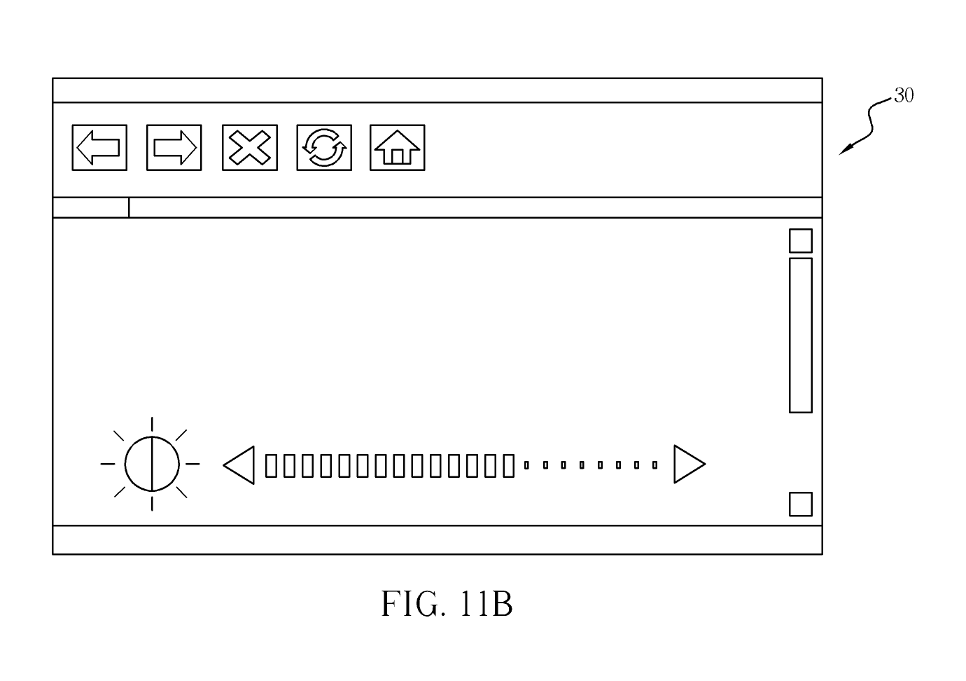

Please refer to FIGS. 5A, 5B, and 11A, which show another embodiment of the present invention. In the present embodiment, the control of volume is described as an example. When the touch object 40 continuously/sequentially contacts the scroll-up area 222 and the fast-scroll-up area 221, the processing element of the touch unit 20 activates a predetermined special function of turning volume up. On the other hand, when the touch object 40 continuously/sequentially contacts the scroll-down area 224 and the fast-scroll-down area 225, the processing element of the touch unit 20 activates a predetermined special function of turning volume down. In this way, time for controlling volume can be reduced and convenience can be enhanced during operation.

Please refer to FIGS. 5A, 5B, and 11B, which show another embodiment of the present invention. In the present embodiment, the control of picture brightness is described as an example. When the touch object 40 continuously/sequentially contacts the scroll-up area 222 and the fast-scroll-up area 221, the processing element of the touch unit 20 activates a predetermined special function of increasing picture brightness. On the other hand, when the touch object 40 continuously/sequentially contacts the scroll-down area 224 and the fast-scroll-down area 225, the processing element of the touch unit 20 activates a predetermined special function of reducing picture brightness. In this way, time for controlling picture brightness can be reduced and convenience can be enhanced during operation.

According to the above, in comparison with prior art, the present invention has the following advantages:

(I) the operations and functions of the electronic product can be expanded without increasing the area of the touch surface;

(II) it is convenient for the user to browse the pictures on the display unit; and

(III) it is easier for the user to operate the electronic product and memorize the finger motions.

Those skilled in the art will readily observe that numerous modifications and alterations of the device and method may be made while retaining the teachings of the invention. Accordingly, the above disclosure should be construed as limited only by the metes and bounds of the appended claims.

What is claimed is :

1. A control method of an electronic product, the electronic product having a touch unit, the touch unit having a touch surface, the touch surface having a plurality of touch areas corresponding to a plurality of predetermined operations respectively, the method comprising steps of:
(a) determining a contact position between a touch object and the touch surface; and
(b) if the contact position is located in the touch area, determining whether the touch object contacts one of the touch areas or contacts at least two touch areas;
wherein if the touch object contacts one of the touch areas, activating one of the predetermined operations corresponding to the touch area contacted by the touch object; and
if the touch object contacts at least two touch areas, activating one of a plurality of predetermined special functions.

2. The control method of claim 1, wherein determining whether the touch object contacts one of the touch areas or contacts at least two touch areas is determining whether the touch object contacts one of the touch areas or continuously contacts at least two touch areas.

3. The control method of claim 2, wherein the touch object continuously contacting at least two touch areas is the touch object contacting and sliding from one touch area to another touch area.

4. The control method of claim 1, wherein determining whether the touch object contacts one of the touch areas or contacts at least two touch areas is determining whether the touch object contacts one of the touch areas or sequentially contacts at least two touch areas in a predetermined time interval.

5. The electronic product control method according to claim 4, wherein the touch object sequentially contacting at least two touch areas in a predetermined time interval is the touch object sequentially clicking one touch area and clicking another touch area shortly thereafter in the predetermined time interval.

6. The control method of claim 1, further comprising a step (c) displaying the predetermined operation or the predetermined special function on a display unit, wherein the display unit is electrically coupled to the touch unit.

7. The control method of claim 4, wherein the predetermined operations corresponding to the respective touch areas comprise a scroll-up operation, a scroll-down operation, a fast-scroll-up operation, a fast-scroll-down operation, a scroll-left operation, a scroll-right operation, a fast-scroll-left operation, a fast-scroll-right operation, and a pause operation.

8. The control method of claim 4, wherein the predetermined special functions comprise a page-up function, a page-down function, a page-left function, a page-right function, a page-previous function, and a page-next function.

9. The control method of claim 1, wherein the predetermined special functions comprise the functions of turning volume up, turning volume down, increasing picture brightness, reducing picture brightness, and activating an application software.

10. The control method of claim 1, wherein the plurality of touch areas are disconnected from each other.

11. The control method of claim 1, wherein the plurality of touch areas are connected to each other.

12. The control method of claim 1, further comprising determining a location of the contact position and performing a corresponding clicking operation if the contact position between the touch object and the touch surface is not located in the touch area in the step (a).

13. The control method of claim 1, wherein actions of the touch object contacting the touch surface comprise sliding, clicking, continuously clicking, or pressing for a period of time.

14. An electronic product, comprising:
at least one touch unit, having a touch surface with a plurality of touch areas; and
at least one control unit, electrically coupled to the touch unit and a display unit, the control unit being for performing at least one predetermined function according to a contact status between a touch object and the touch surface, and for displaying a corresponding result on the display unit;
wherein when the touch object contacts one of the touch areas, the at least one control unit activates a first predetermined operation corresponding to the touch area contacted by the touch object; and
wherein when the touch object contacts at least two adjacent touch areas, the at least one control unit activates a second predetermined operation.

15. The electronic product of claim 14, wherein when a contact position between the touch object and the touch surface is outside the plurality of touch areas, the at least one control unit determines a location of the contact position and performs a corresponding clicking operation.

16. The electronic product of claim 14, wherein each of the touch areas corresponds to a different first predetermined operation.

17. The electronic product of claim 16, wherein the first predetermined operation is a function of a key.

18. The electronic product of claim 14, wherein the first predetermined operation is a function of a key.

19. The electronic product of claim 14, wherein the second predetermined operation comprises a page-up function, a page-down function, a page-left function, a page-right function, a page-previous function, and/or a page-next function.

20. The electronic product of claim 14, wherein the second predetermined operation comprises the functions of turning volume up, turning volume down, increasing picture brightness, reducing picture brightness, and/or activating an application software.
